(19) United States
(12) Patent Application Publication
(10) Pub. No.: US 2012/0275714 A1
(43) Pub. Date: Nov. 1, 2012

(54) DETERMINATION OF AN IMAGE SELECTION REPRESENTATIVE OF A STORYLINE

(76) Inventor: Yuli Gao, Mountain View, CA (US)

(21) Appl. No.: 13/095,674

(22) Filed: Apr. 27, 2011

(51) Int. Cl. G06K 9/62

(52) U.S. Cl. 382/224

(57) ABSTRACT

A system and a method are disclosed that determine a subset of images that are representative of the storyline of an image collection. A value of a coverage function is computed for candidate subsets of images from the image collection, where the coverage function of a candidate subset is computed based on a valuation of each image in the candidate subset and a coverage index of the candidate subset. A candidate subset that corresponds to a maximum value of the coverage function is determined, where the images of the selected candidate subset are representative of the storyline of the collection of images.

### BACKGROUND

With the advent of digital cameras and advance in massive storage technologies, people now have the ability to capture many casual images. The cost of image management can drastically increase with the ever-expanding image collections. Indeed, it is not uncommon to find tens of thousands, if not hundreds of thousands of images in a personal computer. A tool that aids in efficiently managing these large collections of digital assets would be beneficial.

### DESCRIPTION OF DRAWINGS

FIG. 1A is a block diagram of an example of a representative images determination system for determining images representative of the storyline of an image.

FIG. 1B is a block diagram of an example of a computer system that incorporates an example of the representative images determination system of FIG. 1A.

FIG. 2A is a block diagram of an example functionality implemented by an illustrative computerized representative images determination system.

FIG. 2B is a block diagram of an example functionality implemented by an illustrative coverage determination system.

FIG. 3 illustrates an example plot of the normalized face appearance frequency versus of number of individuals in example image collections.

FIG. 4 illustrates an example time-value -graph for an example image collection.

FIG. 5 shows an example image collection.

FIG. 6A shows an example of the top six highest ranking images selected from the example image collection of FIG. 5.

FIG. 6b shows an example of the top six representative images selected from the example image collection of FIG. 5.

FIG. 7 illustrates shows a flow chart of an example process for determining representative images from an image collection.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

An “image” broadly refers to any type of visually perceptible content that may be rendered on a physical medium (e.g., a display monitor or a print medium). Images may be complete or partial versions of any type of digital or electronic image, including: an image that was captured by an image sensor (e.g., a video camera, a still image camera, or an optical scanner) or a processed (e.g., filtered, reformatted, enhanced or otherwise modified) version of such an image; a computer-generated bitmap or vector graphic image; a textual image (e.g., a bitmap image containing text); and an iconographic image.

The term “image forming element” refers to an addressable region of an image. In some examples, the image forming elements correspond to pixels, which are the smallest addressable units of an image. Each image forming element has at least one respective “image value” that is represented by one or more bits. For example, an image forming element in the RGB color space includes a respective image value for each of the colors (such as but not limited to red, green, and blue), where each of the image values may be represented by one or more bits.

“Image data” herein includes data representative of image forming elements of the image and image values.

A “computer” is any machine, device, or apparatus that processes data according to computer-readable instructions that are stored on a computer-readable medium either temporarily or permanently. A “software application” (also referred to as software, an application, computer software, a computer application, a program, and a computer program) is a set of machine-readable instructions that a computer can interpret and execute to perform one or more specific tasks. A “data file” is a block of information that durably stores data for use by a software application.

The term “computer-readable medium” refers to any medium capable storing information that is readable by a machine (e.g., a computer system). Storage devices suitable for tangibly embodying these instructions and data include, but are not limited to, all forms of non-volatile computer-readable memory, including, for example, semiconductor memory devices, such as EPROM, EEPROM, and Flash memory devices, magnetic disks such as internal hard disks and removable hard disks, magneto-optical disks, DVD-ROM/RAM, and CD-ROM/RAM.

As used herein, the term “includes” means includes but not limited to, the term “including” means including but not limited to. The term “based on” means based at least in part on.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one example, but not necessarily in other examples. The various instances of the phrase “in one embodiment” or similar phrases in various places in the specification are not necessarily all referring to the same embodiment.

Described herein are novel systems and methods for determining a subset of images that are representative of the storyline of an image collection. An example system and measure herein facilitate a tool for automatically selecting a subset of n representative images from a collection of N images (n<<N), where the subset maximizes the coverage of the storyline of the image collection.

In an example, representative image selection is a common user task, where a user selects just a few samples from a large collection to capture the storyline of an event. Without automation, users may need to go through an entire large image collection at least once. This manual process can be tedious and can become unfeasible as the size of the image collection grows larger. An example system and measure herein facilitate identifying a subset of images that maximize the coverage of the storyline of an image collection with a bias towards selecting highly valuable photos.

An example system and measure herein does not focus on individual image valuation based on image quality measures or face aesthetics. The system and method are also identity-based, rather than being based solely on quality or aesthetics. An individual image valuation method based on face appearance frequency is used. The identity of a face can be as important as, and In some examples more important than, the aesthetics of the face in the image. In an example system and method herein, image-image relationships are modeled when selecting representative images. Individual image valuation without relationship modeling can be used for ranking, but the top ranked images may not be representative of the storyline of the entire image collection. In an example system and method herein, image relationships are modeled to provide a method for representative image selection.

In an example, the systems and methods described herein facilitate selecting a candidate subset of images that are representative of the storyline of an image collection. A value of a coverage function is computed for candidate subsets of images from a collection of images. The coverage function of a candidate subset is computed based on a valuation of each image in the candidate subset and a coverage index of the candidate subset. The candidate subset that corresponds to a maximum value of the coverage function is determined, wherein the images of the selected candidate subset are representative of the storyline of the image collection.

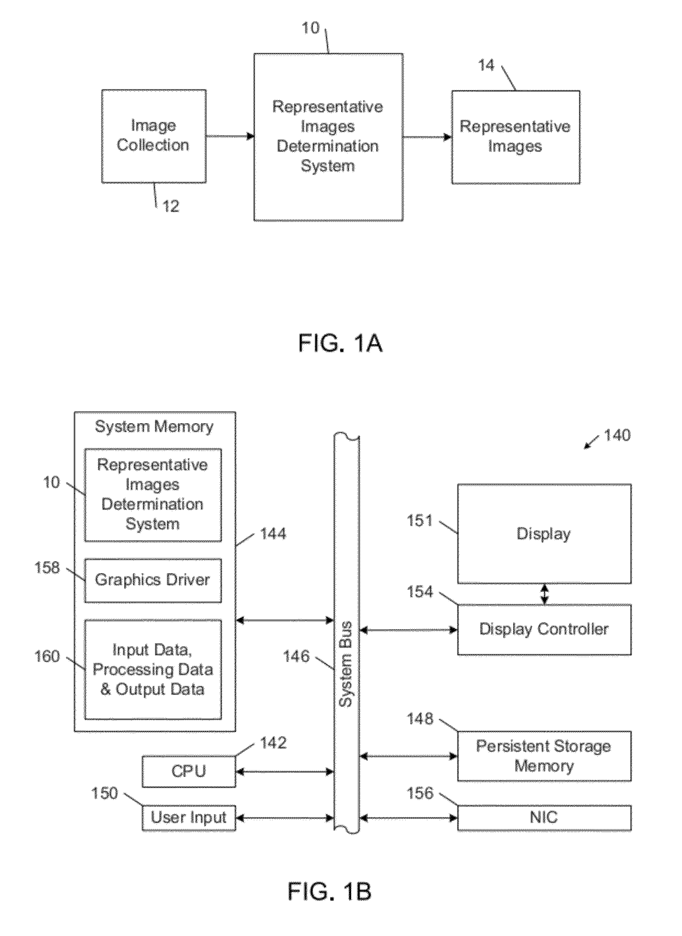

FIG. 1A shows an example of a representative images determination system 10 that determines representative images 14 that are representative of the storyline of image collection 12. The representative images determination system 10 receives image data representative of image collection 12, and, according to example methods described herein, determines representative images 14 that are representative of the storyline of image collection 12. The input to the representative images determination system 10 also can be several collections of images for each of which representative images of respective storylines are determined.

An example source of images is personal photos of a consumer taken of family members and/or friends. As non-limiting examples, the images can be photos taken during an event (e.g., wedding, christening, birthday party, etc.), a holiday celebration (Christmas, July 4, Easter, etc.), a vacation, or other occasion. Another example source is images captured by an image sensor of, e.g., entertainment or sports celebrities, or reality television individuals. The images can be taken of one or more members of a family near an attraction at an amusement park. In an example use scenario, a system and method disclosed herein is applied to images in a database of images, such as but not limited to images captured using imaging devices (such as but not limited to surveillance devices, or film footage) of an area located at an airport, a stadium, a restaurant, a mall, outside an office building or residence, etc. In various examples, each image collection can be located in a separate folder in a database, or distributed over several folders. It will be appreciated that other sources are possible.

FIG. 1B shows an example of a computer system 140 that can implement any of the examples of the representative images determination system 10 that are described herein. The computer system 140 includes a processing unit 142 (CPU), a system memory 144, and a system bus 146 that couples processing unit 142 to the various components of the computer system 140. The processing unit 142 typically includes one or more processors, each of which may be in the form of any one of various commercially available processors. The system memory 144 typically includes a read only memory (ROM) that stores a basic input/output system (BIOS) that contains start-up routines for the computer system 140 and a random access memory (RAM). The system bus 146 may be a memory bus, a peripheral bus or a local bus, and may be compatible with any of a variety of bus protocols, including PCI, VESA, Microchannel, ISA, and EISA. The computer system 140 also includes a persistent storage memory 148 (e.g., a hard drive, a floppy drive, a CD ROM drive, magnetic tape drives, flash memory devices, and digital video disks) that is connected to the system bus 146 and contains one or more computer-readable media disks that provide non-volatile or persistent storage for data, data structures and computer-executable instructions.

A user may interact (e.g., enter commands or data) with the computer system 140 using one or more input devices 150 (e.g., a keyboard, a computer mouse, a microphone, joystick, and touch pad). Information may be presented through a user interface that is displayed to a user on the display 151 (implemented by, e.g., a display monitor), which is controlled by a display controller 154 (implemented by, e.g., a video graphics card). The computer system 140 also typically includes peripheral output devices, such as speakers and a printer. One or more remote computers may be connected to the computer system 140 through a network interface card (NIC) 156.

As shown in FIG. 1B, the system memory 144 also stores the representative images determination system 10, a graphics driver 158, and processing information 160 that includes input data, processing data, and output data. In some examples, the representative images determination system 10 interfaces with the graphics driver 158 to present a user interface on the display 151 for managing and controlling the operation of the representative images determination system 10.

The representative images determination system 10 can include discrete data processing components, each of which may be in the form of any one of various commercially available data processing chips. In some implementations, the representative images determination system 10 is embedded in the hardware of any one of a wide variety of digital and analog computer devices, including desktop, workstation, and server computers. In some examples, the representative images determination system 10 executes process instructions (e.g., machine-readable instructions, such as but not limited to computer software and firmware) in the process of implementing the methods that are described herein. These process instructions, as well as the data generated in the course of their execution, are stored in one or more computer-readable media. Storage devices suitable for tangibly embodying these instructions and data include all forms of non-volatile computer-readable memory, including, for example, semiconductor memory devices, such as EPROM, EEPROM, and flash memory devices, magnetic disks such as internal hard disks and removable hard disks, magneto-optical disks, DVD-ROM/RAM, and CD-ROM/RAM.

The principles set forth in the herein extend equally to any alternative configuration in which representative images determination system 10 has access to image collection 12. As such, alternative examples within the scope of the principles of the present specification include examples in which the representative images determination system 10 is implemented by the same computer system, examples in which the functionality of the representative images determination system 10 is implemented by a multiple interconnected computers (e.g., a server in a data center and a user's client machine), examples in which the representative images determination system 10 communicates with portions of computer system 140 directly through a bus without intermediary network devices, and examples in which the representative images determination system 10 has a stored local copies of image collection 12.

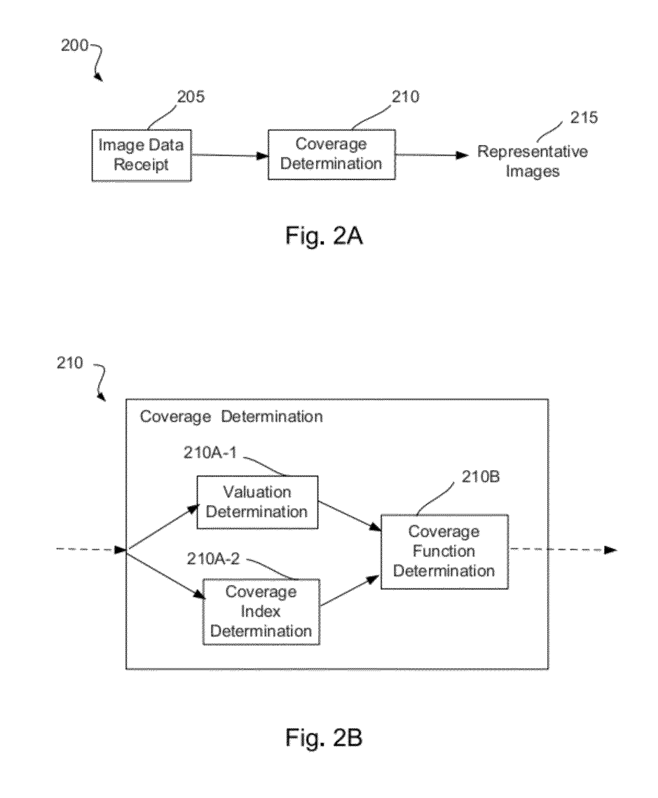

Referring now to FIG. 2A, a block diagram is shown of an illustrative functionality 200 implemented by representative images determination system 10 for determining representative images that are representative of the storyline of an image collection, consistent with the principles described herein. Each module in the diagram represents an element of functionality performed by the processing unit 142. Arrows between the modules represent the communication and interoperability among the modules. In brief, image data representative of images in an image collection is received in block 205, the coverage of candidate subsets of images from the image collection is determined in block 210 using the image data, and representative images 215 that are representative of the storyline of the image collection are determined based on the coverage determined in block 210.

Referring to block 205, image data representative of images in an image collection is received. Examples of image data representative of an image include pixel value and pixel coordinates relative to the image.

Referring to block 210, the coverage of candidate subsets of images from the image collection is determined based on the image data. The coverage of candidate subsets of the image is determined using a coverage determination module. Representative images 215 that are representative of the storyline of the image collection are determined based on the coverage determination in block 210.

In an example, the representative images 215 determined based on the coverage determination of block 210 maximize coverage of the storyline. For example, the storyline can be maximized in terms of time span and/or geo-location diversity. The representative images 215 determined based on the coverage determination of block 210 also can maximize the values of individual selected images, for example, in terms of image quality, face aesthetics, and person identities. The representative images 215 determined based on the coverage determination of block 210 also can minimize the visual redundancy, for example, in terms of avoiding visually similar images like near duplicates.

The coverage determination in block 210 can be made based on a valuation and level of coverage as follows. In a formal framework where the images in the collection are represented as I={I₁, I₂, . . . I_{N}}, where N is the total number of images, V(Iₖ) can de used to represent the valuation function of an image Iₖ, and C(I\{Iₖ₁, Iₖ₂, . . . Iₖₙ}) can be used to represent the function that indicates the level of coverage (including a coverage index) of other unselected images given a selected candidate subset (n<<N). The representative images 215 can be determined as the candidate subset of images that maximizes a coverage computed as follows:

$${max}_{\{ {I}_{{k}_{1}} , {I}_{{k}_{2}} , … , {I}_{{k}_{n}} \} ⋐ I} {\sum }_{{k}_{i}} V ( {I}_{{k}_{i}} ) + C ( I \backslash \{ {I}_{{k}_{1}} , {I}_{{k}_{2}} , … , {I}_{{k}_{n}} \} ) \qquad ( 1 )$$

Enumerating the different candidate subsets of size n that can be selected from the N images in the image collection is a n-combination computation. The computation can be simplified using a greedy objective that selects the best kᵢ₊₁ sample given the already selected candidate subset {Iₖ₁, Iₖ₂, . . . Iₖᵢ}. The computation of Equation (1) can be approximated as:

$${max}_{{k}_{i + 1}} C ( {I}_{{k}_{i + 1}} \vert {I}_{{k}_{1}} , {I}_{{k}_{2}} , … , {I}_{{k}_{i}} ) \qquad ( 2 )$$

where the valuation term in Equation (1) is absorbed into the second term of the equation by treating a selected image as one that is fully covered. In an example, the solution of the greedy selection objective can provide a stable selection. That is, in this example, the new candidate subset generated with the newly selected image does not alter the previously selected candidate subset. In an example, the coverage determination module is also used to implement the greedy selection objective.

FIG. 2B shows an example operation of coverage determination module 210. In block 210A-1, a valuation determination is made of each image in a candidate subset from a collection of images. In block 210A-2, a coverage index determination is made of the candidate subset. In block 210B, a coverage function is determined for the candidate subset, where the coverage function of a candidate subset is computed based on the valuation from block 210A-1 of each image in the candidate subset and the coverage index of the candidate subset from block 210A-2. The processes of FIG. 2B can be repeated for each of a number of different candidate subsets. Representative images 215 that are representative of the storyline of the image collection are determined based on the coverage determination in block 210 as described herein.

Referring to block 210A-1, a valuation determination of each image in a candidate subset is made as follows. The valuation is a measure of attributes of the image content of the images. For example, the valuation can be determined based one or both of a measure of image quality of the image content and a measure of image semantics of the image content. In an example, the valuation can be determined as a combination of the measure of image quality and the measure of image semantics. For example, the valuation of an image can be determined as a linear combination of the image quality and the image semantics of the image. In another example, the measure of image quality and the measure of image semantics can be treated as orthogonal in a vector representation of the valuation, where the value of the valuation is the magnitude of the vector.

Determination of a measure of image quality of an image is described. A measure of image quality can be provided by an approach where images with very low image qualities are penalized, and images with reasonably good quality are distinguished by their content value. With the advance of image capture devices and digital image processing pipelines, even images captured using simples devices (such as common point and shoot cameras) can capture images of reasonable quality under a wide variety of lighting conditions. In an example, a “hinge loss” model can be used to quantify the quality penalty Q((Iₖ)=|q((Iₖ)−T_{q}|−, where q((Iₖ) can be computed using an image quality measure and T_{q} is a predetermined threshold below which images are determined as having low quality. In an example, the image quality measure is generated using an entropy-based method.

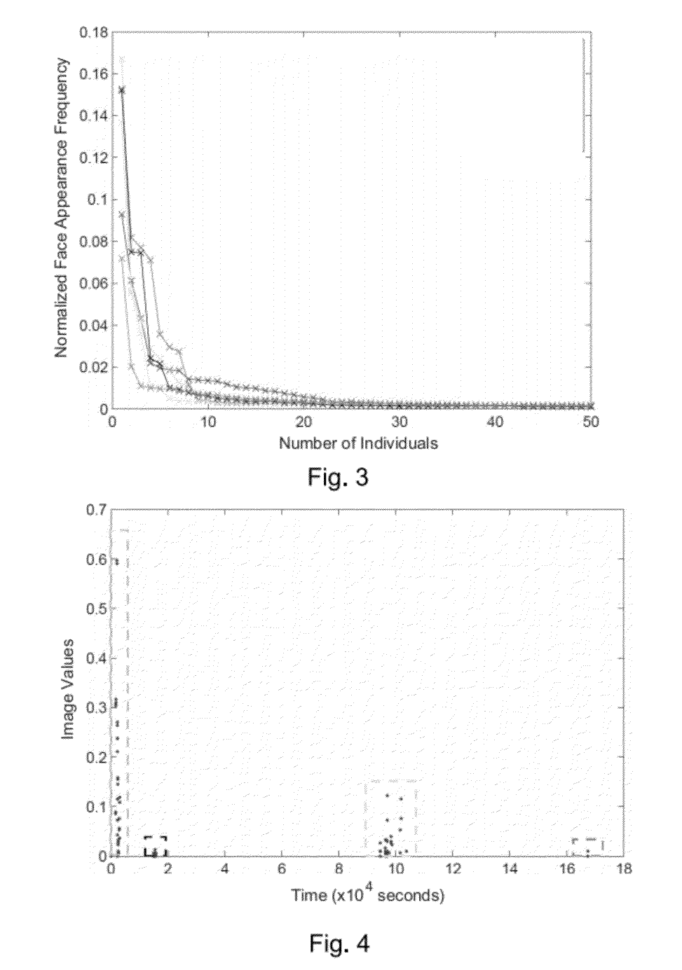

Determination of a measure of image semantic of an image is described. A non-limiting example of image content that may have high semantic value is the object class of humans in an image collection (such as but not limited to a consumer image collection). Humans as image content can be detected using a face detector, such as, for example, a Viola-Jones-type face detector. Not all faces are valued equally. The difference is partly due to aesthetic valuation, or it may be due to emotional attachment regardless of aesthetics. An image collection (such as but not limited to a personal image collection) can include many more images of a select number of people than of other people. The frequency of face appearance of individuals in a collection can provide a strong indication of the personal valuation of the owner of the image collection towards the individuals in the images in the collection. FIG. 3 shows a plot of normalized face appearance frequency versus individuals in six different example image collections, where each x on a line of a collection corresponds to an individual. In each of the six example image collections, a select number of people (individuals at fewer than 10) appear with the greatest frequency. The value of normalized face frequency decays approximately exponentially as the “value” of the individual decreases. As demonstrated in FIG. 3, face frequency can provide a viable measure of the “value” of a person to the individual(s) that captured the images of the image collection.

An image having a “group shot” of individuals can be assigned a high value of image semantics, since group shots can be difficult to accomplish. It can take more effort to assemble individuals and have them pose correctly to make a good image. A higher value of image semantics can be assigned to images with larger groups of individuals. The implementation of a computation according to the following equation can be used to evaluate the semantic value (S(Iₖ)) of an image Iₖ:

$$S ( {I}_{k} ) = {\sum }_{{p}_{i} ∈ {I}_{k}} log ( Freq ( {p}_{i} ) ) \qquad ( 3 )$$

where {pᵢ} is the set of individuals who appear in Iₖ, and Freq(pᵢ) is the appearance frequency of each individual in the entire image collection I. The set {pᵢ} and its frequency vector can be determined using a face clustering technique and associated algorithm(s).

FIG. 4 shows an example “time-value” graph for an example image collection. The x-axis represents the elapsed time (in seconds) since the first image was captured. The y-axis represents the values of valuation of individual images calculated according to block 210A-1. The dots correspond to each image, and the dotted rectangle surrounds each different cluster of images. As can be seen in FIG. 4, images in this example collection are taken sparsely along time, and are clustered into four clusters that correspond to four distinct “sub-events” in the image sequence. If images are selected based solely on the values of the valuation in FIG. 4, (i.e., if a coverage term is not included), it can be seen that samples may be drawn from only the first sub-event, and none from other sub-events. FIG. 4 illustrates that selection of images based on solely the values of the valuation may not provide a good selection, because it does not cover the storyline well. A risk is that a number of very similar images with high quality and good contact may be selected, but this selection may be undesirable due to high information redundancy (e.g., due to near duplicate images).

Reference is made to block 210A-2, where a coverage index determination of the candidate subset, and to block 2108, where a coverage function of the candidate subset is determined based on the valuation and the coverage index. The coverage function C(Iₖ₁, Iₖ₂, . . . Iₖₙ) can be computed based on the coverage index and the valuation as follows :

C(Iₖ_{₁}, Iₖ_{₂}, . . . , Iₖ_{ₙ})=Σᵢ₌₁^{N}C(I₁)·V(Iᵢ) (4)

where C(Iᵢ) is the coverage index of every image in the image collection given the selected n images of the candidate subset, and V(Iᵢ).

In an example, for determining the representative images 215, the candidate subset of n images that maximize the coverage function is selected.

In an example, the coverage index can be determined using a similarity (kernel) function K (Iᵢ, Iₖ_{ⱼ})⊂[0, 1] that is constructed to measure the similarity between pairs of images. The coverage index for an image Iᵢ can be computed according to:

C(Iᵢ)=maxⱼ₌₁ⁿK(Iᵢ, Iₖ_{ⱼ}) (5)

In this example, the coverage function can be determined according to:

$$C ( {I}_{{k}_{1}} , {I}_{{k}_{2}} , … , {I}_{{k}_{n}} ) = {\sum }_{i = 1}^{N} V ( {I}_{i} ) \cdot {max}_{j = 1}^{n} K ( {I}_{i} , {I}_{{k}_{j}} ) \qquad ( 6 )$$

An example implementation of the representative images determination system herein can be performed using an incremental (greedy) setting. An initial candidate subset of representative images can be determined, and a subsequent candidate subset of representative images can be constructed, based on the previous candidate subset. In this example, the subsequent candidate subset is generated by determining the next representative image to add to previous the candidate subset as the unselected image that maximizes the objective. The kernel function K(Iᵢ, Iₖ) can be used to quantify the influence of an image on a previous candidate subset. Since the images taken close in time may be related to each other, the similarity function can be determined a function of time. For example, where the similarity function has a Gaussian functional form, the similarity function can be specified as K (Iᵢ, Iₖ_{ⱼ})=exp(−∥tᵢ−tₖⱼ∥²/2σ²), where tᵢ−tₖⱼ is the time interval between when the two images were taken, and where a controls the size of the neighborhood that a selected image influences. In an example, the coverage index computations for each image can be performed faster if the computation is restricted to the 3σ neighborhood of the selected sample. In an example where images are sparsely distributed, using this neighborhood restriction can result in a sub-linear update for each additional selection to generate a subsequent candidate subset. In an example where geo-location information is available for the images, e.g., where the images include global positioning system (GPS) information, the kernel function can be extended by including a term that takes into account of geo-location distance. As a non-limiting example, the kernel function can include a term exp(−∥dᵢ−dₖⱼ∥²/2σ_{d}²), where ∥dₖⱼ∥ provides a measure of the distance between the locations where the images are captured, and σ_{d} controls the size of the neighborhood for the geo-location measure.

Representative images 215 that are representative of the storyline of the image collection are determined based on results of the coverage determination in blocks 210A-1, 2010A-2, and 210B. To determine the representative images, coverage determination module facilitates determining the selected candidate subset with high valuation-value images that also at the same time maximizes the coverage of the entire storyline.

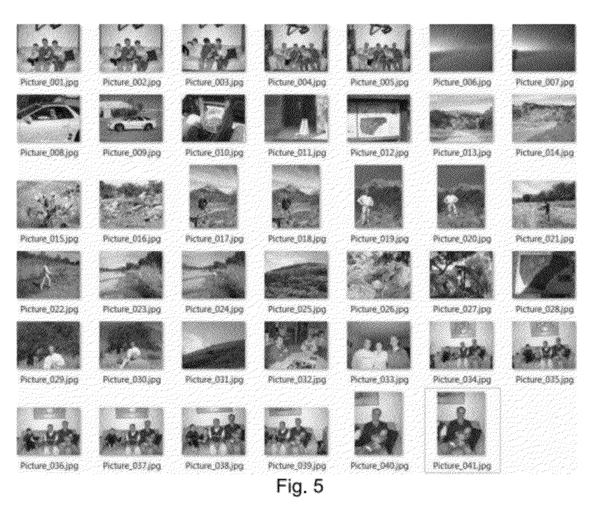

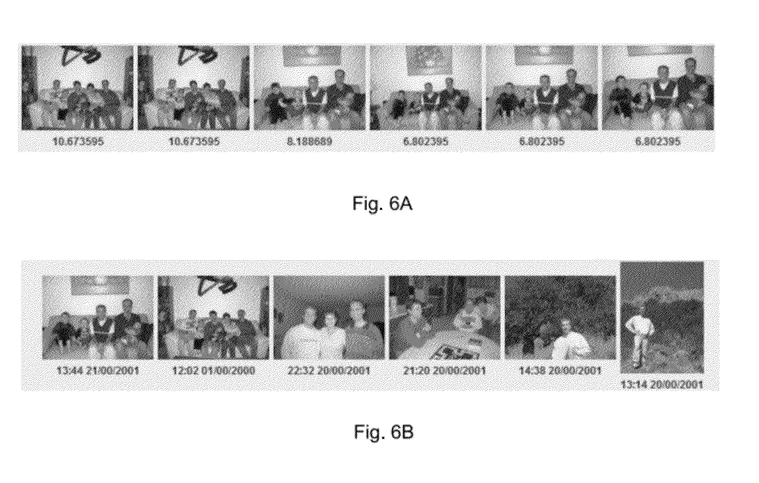

The results of an example implementation of a system and method described herein is described. FIG. 5 shows an example image collection of personal photos of a family trip. FIG. 6A shows the six highest-ranking images from the collection based solely on values of the valuation. FIG. 6A shows six representative images from a selected candidate subset according to the principles herein. As can be seen from a comparison of FIG. 6A and 6B, the representative images selection in FIG. 6B identify the valuable people group shots and at the same time captures several portions of the storyline of the trip. The ranking approach in FIG. 6A selects a highly redundant subset of images since it doesn't take account of image relationships.

In a non-limiting example implementation, the representative images determined according to the principles herein are presented to a user that wants a preview of the contents of a folder or other portion of a database. For example, a functionality can be implemented on a computerized apparatus, such as but not limited to a computer or computing system of a desktop or mobile device (including hand-held devices like smartphones), where a user is presented with the representative images of the storyline of the images in a folder when the user rolls a cursor over the folder. In another example, the systems and methods herein can be a functionality of a computerized apparatus, such as but not limited to a computer or computing system of a desktop or mobile device (including hand-held devices like smartphones), that is executed on receiving a command from a user or another portion of the computerized apparatus to present a user with the representative images of the storyline of the images in a folder.

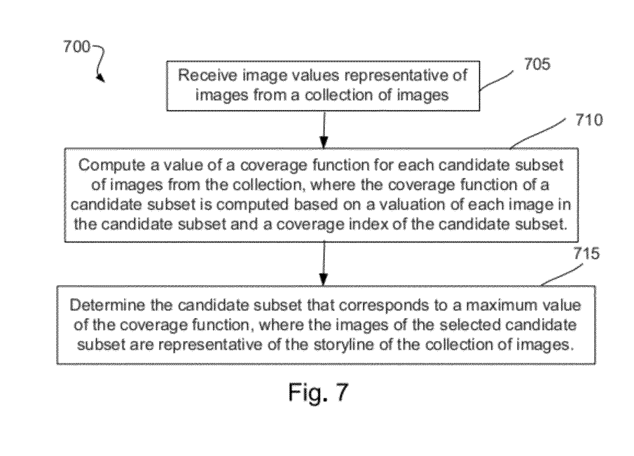

FIG. 7 shows a flow chart of an example process 700 for determining representative images that are representative of the storyline of an image collection. The processes of FIG. 7 can be performed by modules as described in connection with FIG. 2A. In block 705, image data representative of images from a collection of images is received. In block 710, a value of a coverage function is computed for each candidate subset, where the coverage function of a candidate subset is computed based on a valuation of each image in the candidate subset and a coverage index of the candidate subset. In block 715, the candidate subset that corresponds to a maximum value of the coverage function is determined, where the images of the selected candidate subset are representative of the storyline of the collection of images.

Many modifications and variations of this invention can be made without departing from its spirit and scope, as will be apparent to those skilled in the art. The specific examples described herein are offered by way of example only, and the invention is to be limited only by the terms of the appended claims, along with the full scope of equivalents to which such claims are entitled.

As an illustration of the wide scope of the systems and methods described herein, the systems and methods described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

All references cited herein are incorporated herein by reference in their entirety and for all purposes to the same extent as if each individual publication or patent or patent application was specifically and individually indicated to be incorporated by reference in its entirety herein for all purposes. Discussion or citation of a reference herein will not be construed as an admission that such reference is prior art to the present invention.

What is claimed is:

1. A method performed by a physical computer system comprising at least one processor, said method comprising:
computing a value of a coverage function for candidate subsets of images from a collection of images, wherein the coverage function of a candidate subset is computed based on a valuation of each image in the candidate subset and a coverage index of the candidate subset; and
determining the candidate subset that corresponds to a maximum value of the coverage function, wherein the images of the selected candidate subset are representative of the storyline of the collection of images.

2. The method of claim 1, wherein the valuation comprises a measure of image quality of image content.

3. The method of claim 2, wherein the measure of image quality is determined based on an entropy-based measure.

4. The method of claim 1, wherein the valuation comprises a measure of semantic value of image content.

5. The method of claim 4, wherein the measure of semantic value is determined based on an appearance frequency of individuals in the collection.

6. The method of claim 5, wherein the semantic value (S(Iₖ)) of image Iₖ is computed according to:
$$S ( {I}_{k} ) = {\sum }_{{p}_{i} ∈ {I}_{k}} log ( Freq ( {p}_{i} ) )$$
wherein {pᵢ} is the set of individuals appearing in image Iₖ, and wherein Freq(pᵢ) is the appearance frequency of individual i in the collection.

7. The method of claim 1, further comprising computing the value of the coverage function of a candidate subset based on a summation over the collection of the coverage index of each image in the candidate subset weighted by the valuation of that respective image.

8. The method of claim 7, wherein the value of the coverage function is computed according to:
C(Iₖ_{₁}, Iₖ_{₂}, . . . Iₖ_{ₙ})=Σᵢ₌₁^{N}C(Iᵢ)·V(Iᵢ)
wherein C(Iₖ_{₁}, Iₖ_{₂}, . . . Iₖ_{ₙ}) is the coverage function over the n images in the candidate subset, Iₖ, is each image of the candidate subset, N is the number of images in the collection, C(Iᵢ) is the coverage index of the images in the collection given the n images in the candidate subset, and V(Iᵢ) is the valuation of image i in the collection.

9. The method of claim 8, wherein the coverage index C(Iᵢ) is computed according to:
C(Iᵢ)=maxⱼ₌₁ⁿK(Iᵢ, Iₖ_{ⱼ})
wherein K(Iᵢ, Iₖ_{ⱼ}) is a kernel function that is a measure of similarity over the n images in the candidate subset.

10. The method of claim 9, wherein the kernel function is computed as a Gaussian according to K (Iᵢ, Iₖⱼ)=exp(−∥tᵢ−tⱼ∥²/2σ²).

11. The method of claim 10, wherein the Gaussian further comprises a term for geo-location.

12. A computerized apparatus, comprising:
a memory storing computer-readable instructions; and
a processor coupled to the memory, to execute the instructions, and based at least in part on the execution of the instructions, to:
compute a value of a coverage function for candidate subsets of images from a collection of images, wherein the coverage function of a candidate subset is computed based on a valuation of each image in the candidate subset and a coverage index of the candidate subset; and
determine the candidate subset that corresponds to a maximum value of the coverage function, wherein the images of the selected candidate subset are representative of the storyline of the collection of images.

13. The apparatus of claim 12, further comprising instructions to determine the valuation of an image using a measure of semantic value of image content.

14. The apparatus of claim 13, wherein the measure of semantic value S(Iₖ)) of image Iₖ is computed according to:
$$S ( {I}_{k} ) = {\sum }_{{p}_{i} ∈ {I}_{k}} log ( Freq ( {p}_{i} ) )$$
wherein {pᵢ} is the set of individuals appearing in image Iₖ, and wherein Freq(pᵢ) is the appearance frequency of individual i in the collection.

15. The apparatus of claim 12, further comprising instructions to compute the value of the coverage function of a candidate subset based on a summation over the collection of the coverage index of each image in the candidate subset weighted by the valuation of that respective image.

16. The apparatus of claim 15, wherein the value of the coverage function is computed according to:
$$C ( {I}_{{k}_{1}} , {I}_{{k}_{2}} , … , {I}_{{k}_{n}} ) = {\sum }_{i = 1}^{N} V ( {I}_{i} ) \cdot {max}_{j = 1}^{n} K ( {I}_{i} , {I}_{{k}_{j}} )$$
wherein C(Iₖ_{₁}, Iₖ_{₂}, . . . , Iₖ_{ₙ}) is the coverage function over the n images in the candidate subset, kis each image of the candidate subset, Nis the number of images in the collection, V(Iᵢ) is the valuation of image i in the collection, wherein the coverage index C(Iᵢ) is computed according to: C(Iᵢ)=maxⱼ₌₁ⁿK(Iᵢ, Iₖ_{ⱼ}), and wherein K(Iᵢ, Iₖ_{ⱼ}) is a kernel function that is a measure of similarity over the n images in the candidate subset.

17. The apparatus of claim 12, wherein the processor is in a computer, a computing system of a desktop device, or a computing system of a mobile device.

18. A computer-readable storage medium, comprising instructions executable to:
compute a value of a coverage function for candidate subsets of images from a collection of images, wherein the coverage function of a candidate subset is computed based on a valuation of each image in the candidate subset and a coverage index of the candidate subset; and
determine the candidate subset that corresponds to a maximum value of the coverage function, wherein the images of the selected candidate subset are representative of the storyline of the collection of images.

19. The computer-readable storage medium of claim 18, further comprising instructions to determine the valuation of an image using a measure of semantic value of image content, and wherein the measure of semantic value S(Iₖ)) of image Iₖ is computed according to:
$$S ( {I}_{k} ) = {\sum }_{{p}_{i} ∈ {I}_{k}} log ( Freq ( {p}_{i} ) )$$
wherein {pᵢ} is the set of individuals appearing in image Iₖ, and wherein Freq(pᵢ) is the appearance frequency of individual i in the collection.

20. The computer-readable storage medium of claim 18, further comprising instructions to compute the value of the coverage function of a candidate subset based on a summation over the collection of the coverage index of each image in the candidate subset weighted by the valuation of that respective image.

21. The computer-readable storage medium of claim 20, wherein the value of the coverage function is computed according to:
$$C ( {I}_{{k}_{1}} , {I}_{{k}_{2}} , … , {I}_{{k}_{n}} ) = {\sum }_{i = 1}^{N} V ( {I}_{i} ) \cdot {max}_{j = 1}^{n} K ( {I}_{i} , {I}_{{k}_{j}} )$$
wherein C(Iₖ_{₁}, Iₖ_{₂}, . . . , Iₖ_{ₙ}) is coverage function over the n images in the candidate subset, Iₖ_{ᵢ} is each image of the candidate subset, N is the number of images in the collection, V(Iᵢ) is the valuation of image i in the collection, wherein the coverage index C(Iᵢ) is computed according to C(Iᵢ)=maxⱼ₌₁ⁿK(Iᵢ, Iₖ_{ⱼ}), and the coverage index C(Iᵢ)is computed according to C(Iᵢ)=maxⱼ₌₁ⁿK(Iᵢ, Iₖ_{ⱼ}), and wherein) K(Iᵢ, Iₖ_{ⱼ}) is a kernel function that is a measure of similarity over the n images in the candidate subset.
